(19) United States
(12) Patent Application Publication
(10) Pub. No.: US 2018/0330385 A1
(43) Pub. Date: Nov. 15, 2018

(54) AUTOMATED AND DISTRIBUTED VERIFICATION FOR CERTIFICATION AND LICENSE DATA

(71) Applicant: Atlas Certified, LLC, Raleigh, NC (US)

(72) Inventors: David Lindsay Johnson, Raleigh, NC (US); Michael Boslet, Raleigh, NC (US)

(21) Appl. No.: 15/976,814

(22) Filed: May 10, 2018

Related U.S. Application Data
(60) Provisional application No. 62/506,510, filed on May 15, 2017.

(51) Int. Cl. G06Q 30/00; G06Q 10/10

(52) U.S. Cl. CPC G06Q 30/018; G06Q 10/107; G06Q 10/1053

(57) ABSTRACT

The inventive system provides a technological solution to the problem of automating the verification of Cert Org credential records, as well as monitoring licenses/certifications with a compliance screenshot, and providing automated alerts/notifications and data analytics. The verification and monitoring process can be used for employees, freelancers or consultants, represented licensees (e.g., contractors, nurses, insurance brokers, accountants, pharmacists, etc.) and partners or customers (e.g. drug distribution, insurance, contractors, etc.) across Cert Orgs. Cert Orgs include technology providers, State License Boards, Federal Databases and many others. The system provides corporations with continuous verification of credential data across structured and unstructured data outputs of certifying organizations. Fully automated and scheduled monitoring allows the system to verify credential status, with corresponding compliance screenshots, on an ongoing basis with custom triggers for alerts in change in status, whether normal expiration, disciplinary or administrative action, revocations and pre-expiration for proactive decisions (e.g., remove freelancer or drug distribution customer from portfolio).

### CROSS REFERENCE

The present application claims priority to U.S. Provisional Application No. 62/506,510, “Methods And Systems For A Fully Automated And Distributed Verification Engine For Certifications And Licenses For The On-Demand Job Economy Batching Records Against Multiple Databases, Standardizing Data Output, Monitoring With Proactive Notifications For Expiration And Revocation, Screenshot Support For Compliance And Analytics,” filed May 15, 2017, the content of which is hereby incorporated by reference in its entirety.

### TECHNICAL FIELD

The present invention relates generally to the fields of information technology, computer software, and data analytics. More particularly, the present invention relates, but is by no means limited, to computational methods and systems to automate today's manual process in order to aggregate, verify and monitor professional credential data of employees, freelancers, contractors, customer, service professionals and prospective employees for the on-demand gig economy.

### BACKGROUND

Technological innovation is entering a period of unprecedented expansion, transitioning to an on-demand and skilled labor force and creating a revolution in the exponential growth and use of data. The need for verified professionals and number of certifications/licenses to manage across every industry is enormous and growing, creating a time consuming, inefficient and expensive challenge for employers in confirming and managing credentials of both prospective and hired employees.

The current process of verifying certification and license data today is manual, antiquated and broken. It is labor-intensive, time-prohibitive, error prone, and expensive. Due to rapidly evolving technology, regulation and skill-based education, however, confirming and managing represented skills is more important than ever. For employers, that means significant resources focused away from their core business to confirming, either online or on the phone, multiple certifications across multiple companies for numerous candidates/employees/customers with no consistency across the data output, compliance or simple method for monitoring. There is an unmet need in the industry for providing a trusted and efficient process to verify, organize and monitor certifications, licenses and skills, as well as collect and provide access to a consistent set of data across providers with structured and unstructured outputs. There is also an unmet need in the industry for an automated, centralized credential verification and application solution for the burgeoning human resource market that provides users, companies, hiring executives, recruiting firms and networking websites with precise and up-to-date certification, license, skill and knowledge insights into their applicants, employees, contractors, freelancers, service professionals, customers (drug distribution licenses), partners and employees.

### SUMMARY

The Internet and related computer networking technologies have led to the exponential growth of data, which has in turn created the technological problem of verifying and understanding this data. The Atlas Certified (Atlas) system described herein provides a technological solution to the problem of automating the verification and monitoring of digital records, such as licenses and certifications. The system is designed to provide Atlas customers, which includes individual users and corporations, with continuous verification of credential data across unstructured data outputs of Certifying Organizations (Cert Org). Cert Orgs include technology providers (e.g. Microsoft, Cisco, PMI), State License Boards (e.g. Pharmaceutical, Medical License, Nursing, Contractors), Federal Databases (e.g. DEA, FDA, OIG) and other relevant databases (e.g. Mariner, International Driver Licenses). The verification process can be used for employees, freelancers, consultants, represented licensees, partners, and/or customers. Fully automated and scheduled monitoring allows the system to verify results, including compliance screenshots, on an ongoing basis with custom triggers and alerts for change in status, whether normal expiration, disciplinary or administrative action, revocations and pre-expiration.

The inventive system required the inventors to solve a number of related technological problems. For example, building the inventive system required integration with a variety of web-based systems that provide information via form submissions but do not make available any API (application programming interface). To integrate with these systems, the present inventors created processes to simulate a browser visiting the website and submitting information (requests), and then to parse the returned data (results) to capture pertinent data.

In another embodiment of the inventive system, blockchain technology is employed to make the verification data part of a distributed ledger, thereby creating an unalterable audit log of all of the verifications processed. In this embodiment, the Atlas engine and database becomes a clearinghouse of professional credential data, increasing trust in the data, assuring users, customers and certifying organizations of long term and uninterrupted retention of data for compliance purposes. The inventive professional credential ledger could create a globally searchable database of individuals and their licenses that would output a verification stored in the blockchain, or if one did not exist create one.

The present inventors have also developed a CSV import process to create a comma separated values file. This process is used to automatically build a CSV file in the correct format for a user to use for bulk uploads depending on the verification types they select. This data will be organized, inspected, and calculated to further expand the usefulness of this information the Atlas Certified Educational Counselor (ACEC) described below. This embodiment can be used to put into place a standardization system to govern the process of being certified through the Atlas Certified Standardized Profile (ACSP) program, which is also described below. In another embodiment, users can pre-verify, store and monitor multiple certifications, becoming “Atlas Certified” and differentiating themselves from other candidates.

The present invention can also be used to create a new standard from a one-off and error prone manual verification of certification, credential or skill by a corporation or background check service to an autonomous, continual verification and monitoring process. As a result, the method and apparatus disclosed herein increase efficiency, accuracy and consistency of certification, skill and license data across certifying organizations and industries.

The inventive system described herein provides a solution to a number of technological problems inherent in prior systems for verifying certifications. For example, programmable operational characteristics of the system automatically determine the underlying Certifying Organization (Cert Org), from a pool of thousands, by member data cache, including Cert Org location, Cert Org industry, identification number or member profession. Based on the Cert Org, the Atlas Engine automatically identifies the required data field inputs for verification. The Atlas engine has programmable operational characteristics based on the characteristics of the selected Cert Org, which include API, no-API, CAPTCHA, reCAPTCHA, database, data output, web browser and more. The Atlas engine enables interoperability with multiple Cert Orgs with multiple different data structures and flexible matching algorithm allows permutations of names and helps reduce human input errors in a non-conventional manner, which allows the inventive system to achieve greater accuracy and efficiency. The inventive system aggregates both structured and unstructured data from the portfolio of Cert Orgs, which includes credential member name, address, expiration date, specialty, adverse action, notes and verification screenshot. The system creates a badge for members for simple and efficient sharing and representation of credentials. Furthermore, the automated system monitors verification results, including compliance screenshots, on an ongoing basis with custom triggers and alerts for change in status, whether normal expiration, disciplinary or administrative action, revocations and pre-expiration.

In addition, from selection of the Cert Org to determining data inputs to structuring data output to auto-generated CSVs to monitoring to alerts provides tremendous benefits, including significant improvements in speed and efficiency, over the conventional process of credential verification, which is manual (e.g. phone calls/web access to each independent Cert Org), time consuming, error-prone and creates static data, which in turn creates increased operating risk and liability. The inventive systems and methods of automated credential verification achieves greater accuracy and reduces errors/liability/time over the convention process with each automated component; from determining Cert Org to data inputs to our proprietary matching algorithm to screenshots of actual data to data output to proactive alerts of change in status or adverse action.

Additional aspects of the present invention are described below.

### BRIEF DESCRIPTION OF THE DRAWINGS

FIG. 1 is a flow diagram of a process for creating a new employer.

FIG. 2 is a flow diagram of a process for accessing the verification system as an existing employer.

FIG. 3 is a flow diagram of options available to authorized employers.

FIG. 4 is a flow diagram of a process for credential verification.

FIG. 5 is a flow diagram of a process for searching for a specific member.

FIG. 6 is a flow diagram of a process for searching for all members with specific credentials.

FIG. 7 is a flow diagram of a process for sending email messages.

FIG. 8 is a flow diagram of a process for creating a new member.

FIG. 9 is a flow diagram of a process for accessing the verification system as an existing member.

FIG. 10 is a flow diagram of options available to authorized members.

FIG. 11 is a flow diagram of process for searching and categorizing additional credential data.

FIG. 12 depicts an illustrative computer network suitable for carrying out the present invention.

FIG. 13 depicts an illustrative computer suitable for carrying out the present invention.

FIG. 14 is a flow diagram for a batch credential verification process.

### DETAILED DESCRIPTION OF ILLUSTRATIVE EMBODIMENTS

Overview

One embodiment of the present invention provides clients with comprehensive solutions of automating the verification of records, monitoring those licenses/certifications with compliance screenshot, providing instant alerts/notifications and data analytics. The inventive system is referred to herein as the “Atlas engine” (or sometimes simply “Atlas”). The Atlas engine provides corporations continuous verification of credential data across unstructured data outputs of certifying organizations. The data to be verified can relate to employees, freelancers or consultants, represented licenses (e.g., for contractors, nurses, insurance brokers, accountants, pharmacists, etc.), and partners or customers (e.g., licenses for drug distribution, insurance, contractors, etc.). Atlas can communicate directly with hundreds of certifying organizations to reduce business risk and increase compliance with detailed verification history and screenshots.

The system is designed to automate the aggregation of structured and unstructured data without human intervention across certifying organizations, with the ability to process multiple individuals and/or other verifiable objects with multiple records against multiple source databases in one single step. In another embodiment, a multi-functional system automates the verification process via a custom programmed interface within a client's profile, unifying the process across the board, gathering equivalent data, screenshot support of the verification for compliance, monitoring all organizations in a consistent fashion, automated expiration monitoring, automated revocation notifications and providing analytics that break down all aspects of a certified member's educational and certification background. Fully automated and scheduled monitoring allows engine to verify results, including compliance screenshots, in an ongoing basis with custom triggers and alerts for change in status, whether normal expiration, disciplinary or administrative action, revocations and pre-expiration.

The inventive solution required integration with a variety of web-based systems that provide information via form submissions, but do not make available any API. To integrate with these systems, the present inventors created processes to simulate a browser visiting the website and submitting information (requests), and then parse the returned data (results) to capture pertinent data. Atlas has further updated our provider logic so that new verification provider logic is contained in a single script. As these scripts are deployed to the verification engine it can read them in, register them, and then determine how to interact with any given site. We have also incorporated support for Casper and Phantom JS, which provides more flexibility to more easily access data that may several click deep within a web application. The requests that each service requires to return data vary. Some intentionally incorporate features such as asp.net view state to discourage automated submissions. Others have incorporated CAPTCHA and reCAPTCHA, which required programming to simulate human end user. The Atlas engine performs multiple actions, including solving captchas, persisting session and form data similar to that of an end user's browser, automatically capture screen shot of what the verification result would appear like in a human end user browser for compliance. The Atlas System was designed to be flexible so that is can submit the necessary cookies, form variables, session data and query string data as part of its request. In some instances, a series of requests/submissions must be performed to successfully retrieve the desired information. The engine has an improved ability to intelligently parse names and matching logic, which increases flexibility in name permutations and other data fields, to help reduce false negatives. Since each response is designed to be viewed by a user in a browser, the data is structured to be presented visually. This presents challenges in parsing the response to extract specific information such as the name of a certification or the associated expiration date. Our process utilizes a combination of techniques to turn the unstructured data into usable information that can be tracked in the system. When possible, the system will utilize XPath to parse the response and extract specific nodes of data based on an XPath query. This allows the system to extract data from a specific class, id, element, attribute, or a sequence of various selectors. For some services that process will not work because the HTML returned by the service contains duplicate nodes or is missing key elements such as ids or classes that would allow easily extract the data, our fall back is to manually parse the data, selectively identifying the location of key pieces of information and then refining the parsing of the results to extract the specific data. Another challenge of integrating with these 3rd party systems was to ensure that our platform was not completely dependent on their current availability to return timely results. Through utilizing a queuing process, when a user submits a request the system will queue that request for processing. This allows the system to scale to handle bulk requests, but also helps ensure that if a request fails (for example if there is an issue with the 3^{rd} party service) that the system can queue the request until the service is either back online, or the underlying issue has been addressed. Through addressing requests asynchronously, and by storing the appropriate credentials, the Atlas system is also able to re-verify certifications on a scheduled basis to ensure the long-term accuracy of its data.

Another embodiment of our invention is to incorporate blockchain technology in order to make our verification data part of the distributed ledger, thereby creating an unalterable audit log of all of the verifications processed. The Atlas engine and database becomes a clearinghouse of professional credential data, increasing trust in the data we return as transactions/storage, the audit log, assuring users, customers and certifying orgs of long term and uninterrupted retention of data for compliance purposes. Our professional credential ledger invention would create a globally searchable database of individuals and their licenses that would output a verification stored in the blockchain, or if one did not exist create one.

The methods and systems of the invention perform on-demand skill, license and certification verification for applicants, employees or customer's data sorting, analytics through customized Application Programing Interface (API) feed(s), cloud-based web solution or a customized application for anytime, anywhere access. We have also updated the CSV import to automatically build a CSV file in the correct format for a user to use for bulk uploads depending on the verification types they select. This data will be organized, inspected, and calculated to further expand the usefulness of this information through our proprietary Atlas Certified Educational Counselor (ACEC). We will put into place a first ever standardization system to govern the purpose of being certified through our Atlas Certified Standardized Profile (ACSP) program.

In another embodiment of the present invention, users can pre-verify, store and monitor multiple certifications, becoming “Atlas Certified” and differentiating themselves from other candidates. One advantage of the invention disclosed herein is that it performs all of the verification, monitoring and sorting, allowing clients to focus on running their business and reduce risk, rather than trying to organize and maintain static, unverified and time intensive lists of credentials. Clients never need to import or synch their data, and the online portal is secured with high level encryption to guarantee data protection. Another advantage of the invention disclosed herein is that it monitors and alerts users/clients to changes in certification and/or license status. Users and clients will have anytime, anywhere access to their data. Another advantage of the invention disclosed herein is that it provides significant capabilities around data and analytics from the micro (user certifications) to the macro (selecting facility location based on available skillset of population).

The Atlas system provides a new standard from a one-off and error prone manual verification of certification, credential or skill by a corporation or background check service to an autonomous, continual verification and monitoring process. As a result, the inventive method and apparatus increase efficiency, accuracy and consistency of certification, skill and license data across certifying organizations and industries, including Information Technology (IT), Healthcare, Pharmaceutical, Insurance, Contractor Referral Companies, Freelancing, Manufacturing, Finance and Accounting. The invention disclosed herein provides significant capabilities around Data and Analytics from the micro (user or company certifications and licenses) to the macro (selecting facility location based on available skillset of population).

The Atlas system further provides the first automated certification verification, monitoring and data solution. It is a customized Application Programing Interface (API) feed(s), cloud-based web solution focused on our increasingly on-demand and skill-based economy by verifying and monitoring certification and license data for users, retrieval of all relevant certification data points across providers, freelancers, contractors, applicants, employees, partners, customers, data sorting, analytics, monitoring and other functions to revolutionize the management and monitoring process of certification, license and background verification across industries. We have added screenshot support of the verification for compliance, monitoring all organizations in a consistent fashion, automated expiration monitoring, automated revocation notifications. The software modules ensure consistency across the certification and license provider data by requesting specific equivalent data, monitoring all organizations in a consistent fashion in order to automate the aggregation of structured and unstructured data without human intervention across certifying organizations with the ability to process multiple individuals and/or other verifiable objects with multiple records against multiple source databases in one single step. Atlas has further updated our provider logic so that new verification provider's logic is contained in a single script. As these scripts are deployed to the verification engine it can read them in, register them, and then determine how to interact with any given site. We have also incorporated support for Casper and Phantom JS, which provides more flexibility to more easily access data that may several click deep within a web application.

The Atlas system also provides corporations instant and continuous verification of credential data across unstructured data outputs of certifying organizations, which includes employees, freelancers or consultants represented licenses (e.g. contractors, nurses, insurance brokers, accountants, pharmacists, etc.) and partners or customers (e.g. drug distribution, insurance, contractors, etc.) Atlas communicates directly with over two hundred certifying organizations to reduce business risk and increase compliance with detailed verification history and screenshots.

Individuals who meet certification standards will earn an “Atlas Certified” seal for each certification/skill verified, creating a standard and mechanism to substantiate their resume and profile representations. Candidates who qualify for the seal will automatically find it placed on their client profile next to certifications earned. Certification is a free service to our users. Paid membership, however, will provide a candidate with a plethora of career improving possibilities. Users may join the database, prequalify and verify certification(s) and skills, differentiating themselves from other candidates and allowing them to find jobs that match their qualifications.

The inventive technologies disclosed herein cover a method for verifying credential data on individuals or companies by utilizing custom created interfaces, modules and security that will communicate with collaborating databases. These collaborators include technology companies and affiliates, educational institutions and affiliates, financial organizations, public records for criminal and other background infractions, and any other public and/or private databases made available either as a free access in public domain and/or part of any business agreement or arrangement. Companies looking to hire for positions can become Atlas Certified members and have access to the extensive database of verified (or unverified) individuals available for positions. Human resource departments will be able to readily find qualified individuals in moments through the use of our filters provided to cull potential employees based on specific requirements or reduce risk by ensuring their employees, freelancers or contractors have the represented skills, licenses or certifications. Companies may also post jobs available and request member applications that meet specific requirements. Tiered service plans will provide companies with the level of verifications, monitoring and job postings.

The present invention covers the Atlas Certified module to ensure consistent data output between certificates, credentials and skills. Currently, the phone and manual online verification alternatives provides little or no consistency between certification/credential providers. For example, some provide a simple confirmation that the user does or does not have the certificate in question, while others provide test date, while others provide expiration date. Atlas Certified software was developed to retrieve additional data from each provider to ensure consistent output and monitoring. Atlas has further updated our provider logic so that new verification provider logic is contained in a single script. As these scripts are deployed to the verification engine it can read them in, register them, and then determine how to interact with any given site. We have also incorporated support for Casper and Phantom JS, which provides more flexibility to more easily access data that may several click deep within a web application. The requests that each service requires to return data vary. Some intentionally incorporate features such as asp.net view state to discourage automated submissions. Others have incorporated CAPTCHA and reCAPTCHA, which required programming to simulate human end user. The Atlas engine performs multiple actions, including solving captchas, persisting session and form data similar to that of an end user's browser, automatically capture screen shot of what the verification result would appear like in a human end user browser for compliance. The Atlas System was designed to be flexible so that is can submit the necessary cookies, form variables, session data and query string data as part of its request. In some instances, a series of requests/submissions must be performed to successfully retrieve the desired information. We have further updated the engine with an improved ability to intelligently parse names and matching logic, which increases flexibility in name permutations and other data fields, to help reduce false negatives.

Since each response is designed to be viewed by a user in a browser, the data is structured to be presented visually. This presents challenges in parsing the response to extract specific information such as the name of a certification or the associated expiration date. Our process utilizes a combination of techniques to turn the unstructured data into usable information that can be tracked in the system. Our system will utilize XPath, when possible, to parse the response and extract specific nodes of data based on an XPath query. This allows the system to extract data from a specific class, id, element, attribute, or a sequence of various selectors. For some services that process will not work because the HTML returned by the service contains duplicate nodes or is missing key elements such as ids or classes that would allow the system to easily extract the data, our fall back is to manually parse the data, selectively identifying the location of key pieces of information and then refining the parsing of the results to extract the specific data.

Another challenge of integrating with these 3rd party systems was to ensure that our platform was not completely dependent on their current availability to return timely results. Through utilizing a queuing process, when a user submits a request the system will queue that request for processing. This allows the system to scale to handle bulk requests, but also helps ensure that if a request fails (for example if there is an issue with the 3rd party service) that the system is able to queue the request until the service is either back online, or the underlying issue has been addressed. Through addressing requests asynchronously, and by storing the appropriate credentials, the Atlas system is also able to re-verify certifications on a scheduled basis to ensure the long-term accuracy of its data and provide proactive monitoring and notifications around expirations and revocations. The system is designed to automate the aggregation of structured and unstructured data without human intervention across certifying organizations with the ability to process multiple individuals and/or other verifiable objects with multiple records against multiple source databases in one single step. According to another embodiment of the present invention, a multi-functional system automates the verification process via a custom programmed interface within a client's profile, unifying the process across the board, gathering equivalent data, screenshot support of the verification for compliance, monitoring all organizations in a consistent fashion, automated expiration monitoring, automated revocation notifications and providing analytics that break down all aspects of a certified member's educational and certification background. Fully automated and scheduled monitoring allows engine to verify results, including compliance screenshots, in an ongoing basis with custom triggers and alerts for change in status, whether normal expiration, disciplinary or administrative action, revocations and pre-expiration. Another embodiment of our invention is to incorporate Blockchain technology in order to make our verification data part of the distributed ledger, thereby creating an unalterable audit log of all of the verifications processed. The Atlas engine and database becomes a clearinghouse of professional credential data, increasing trust in the data we return as transactions/storage, the audit log, assuring users, customers and certifying orgs of long term and uninterrupted retention of data for compliance purposes. Our professional credential ledger invention would create a globally searchable database of individuals and their licenses that would output a verification stored in the blockchain, or if one did not exist create one.

The present invention covers unifying the process certification and licenses data across the industry, gathering equivalent data, monitoring all organizations in a consistent fashion, and providing analytics that break down all aspects of a licenses and certification background; thus enhancing demographics correlation to further the certification holder's career path through our Atlas Certified Smart Education Planner (ACSEP). This data will be organized, inspected, and calculated to further expand the usefulness of this information through our proprietary Atlas Certified Educational Counselor (ACEC). We will put into place a first ever standardization system to govern the purpose of being certified through our Atlas Certified Standardized Profile (ACSP) program.

The present invention also covers a proprietary Applicant Job Match Making System: algorithms that accurately pair the right applicants with the right jobs. Employers can specify criteria and filter applicants by percent match of their ideal hire. Another embodiment of the present invention cover a proprietary Employer Job Match Making System: algorithms that allow our certified applicants to create their ideal employment situation.

The systems and methods described herein provide job applicants with a ranked list of companies who come nearest to their paradigm. Members will then also be made aware of how well they match their dream job. If an individual is lacking certification, education, or any other tools or status necessary for such a position, the systems and methods described herein provide a proposed plan of steps needed to raise them to a status equal to the job they seek. This data provides an opportunity to the certification companies to better understand demand in their market. In another embodiment of the present invention, member activity will be tracked and organized. Private ranking systems will allow a member to apply for jobs with confidence. Members will know if they are over-qualified or under-qualified for a position, thereby reducing inappropriate applicants. Suggested job opportunities will automatically populate a member's “Opportunity Page” alerting them of all positions for which they are the right fit.

The proprietary systems and methods described herein can further aggregate member data to assist them in making career path decisions, including living badges to provide proof of credential. Members will be alerted to upcoming expirations of their certifications and licenses, and be provided with suggestions as to how to improve their income potential. Further certifications, qualifications needed to obtain better positions, and other ways to improve their hiring profile will be clearly addressed. Atlas Certified, in partnership with companies who provide certification, can offer discounted rates for further education if members sign up through the Atlas Portal.

The methods and systems described herein cover a proprietary “Real World Skills Certification” that will test a member's actual applicable skill set in lieu or in addition to technical certification. Employers have often struggled with candidates that look great on paper but lack the professional experience to handle the job. Members who apply for our RWS Certification will earn a ranking based on their true expertise in a particular technology through extensive online testing and personal interview. Multiple identity checks have been set in place to ensure the individual taking the test is the actual applicant. An additional feature of the RWS Certification is that it allows those candidates who have real life experience in a specific technology, but could not afford the coursework, to earn a RWS Seal in lieu of an Atlas Certified Seal next to the technology they excel in.

In one embodiment of the present invention, specific testing results and percentage ranks of any individual's RWS Certification can be made available to potential employers. Tracking and recording of all internal messaging systems will ensure communications between employers and potential hires are reviewed for security purposes. Proprietary messaging software will allow employers to communicate by text messaging, voice or video chat all within the protective umbrella of the Atlas Certified (AC) security system. In yet another embodiment of the present invention, all communication between Employers and Applicants will be limited to AC's messaging systems. Individuals will have unique Atlas Certified email addresses, video, voice and text messaging services, and phone numbers that are to be used throughout the hiring process.

In another embodiment, Atlas Certified can be designed to utilize ASP.NET (C#) with a MSSQL backend. This is a proven enterprise level development stack with a consistent track record on many complex and highly visited web applications. AC can quickly grow to accommodate large numbers of users. Where possible and necessary, caching will be implemented (such as on content pages) to ensure information can quickly and efficiently be retrieved. As recognized by those skilled in the art, the implementation of the methods described herein may be accomplished using various software platforms and languages, including HTML/JavaScript/CSS compatible with Firefox, Safari, Chrome, and IE9, for example. Another embodiment of our invention is to incorporate Blockchain technology in order to make our verification data part of the distributed ledger, thereby creating an unalterable audit log of all of the verifications processed. The Atlas engine and database becomes a clearinghouse of professional credential data, increasing trust in the data we return as transactions/storage, the audit log, assuring users, customers and certifying orgs of long term and uninterrupted retention of data for compliance purposes. Our professional credential ledger invention would create a globally searchable database of individuals and their licenses that would output a verification stored in the blockchain, or if one did not exist create one.

Additionally, the system and methods described herein could serve as a hub for the advancement of technological education in general. Leaders in the industry could be invited to participate in educational podcasts, discounts will be given towards certification coursework and testing through participating affiliates. In addition, the following programs may be developed:
1. Atlas Certified Standardized Profile (ACSP)—Standardization system to govern the certifications and credentials industry.
2. Atlas Certified Smart Education Planner (ACSEP)—Analytics to break down all aspects of a certified member's educational and certification background; thus enhancing demographics correlation to further the certification holder's career path.
3. Atlas Certified Educational Counselor (ACEC)—Organize, inspect, and analyze data to further expand the usefulness of this information for both user and company.
4. Career Path Development (Develop career paths through our ACSEP and ACEC programs that now have a measurable meaning (much like a college or university degree) through our ACSP program.)
5. Atlas Education Points (AEPs)—Members will earn Atlas Education Points for enrolling and completing Atlas Certified continuing education courses. These courses will be available online and members must pass a final exam to earn an AEP. Employers will be able to see the exact rank of an individual's performance on an AEP exam.
6. Atlas Certified Networking Events—Atlas Certified will host location events across the country where potential employers, certification programs, and potential employees can converge and network.
7. Atlas Certified Live Interview Service/Video Module—
   a. Corporate Members can schedule live, real-time video interviews with potential applicants through Atlas Certified's Interview Video Module
   b. Employers can pre-record video interviews which applicants can interact with on their own time. Applicants will answer the taped questions in a live recording session over their preferred device. This will allow multiple interviews for the same post to occur at the same time. To filter the applicant pool, employers can choose to end the pre-recorded interview with a series of multiple choice questions based on the video interview. Answers will be coded with point values by the employer and an applicant's video interview will be ranked by their point score.
8. Atlas Certified Scholarship Programs—Due to the exorbitant costs of network certification, Atlas, in conjunction with Certification Companies, will accept applications and offer several scholarships per year for free tuition to deserving individuals who wish to complete a specific technological certification course.
9. Atlas Certified Educational Financial Aid—In order to facilitate the ability of members to earn technological certifications, Atlas Certified will provide financial aid to those members who qualify.

In one embodiment, an applicant enters their credentials for each vendor certification and licenses to the Atlas Certified database. A custom programmed application or API interface communicates and confirms the applicant's certification accounts with each respective vendor. The vendor's certifications or licenses are confirmed. Immediately thereafter, the Atlas Certified databases are updated and are immediately live with new credentials. All databases are indexed and searchable. Finally, the custom client API interface communicates verified data and updates back to client database(s).

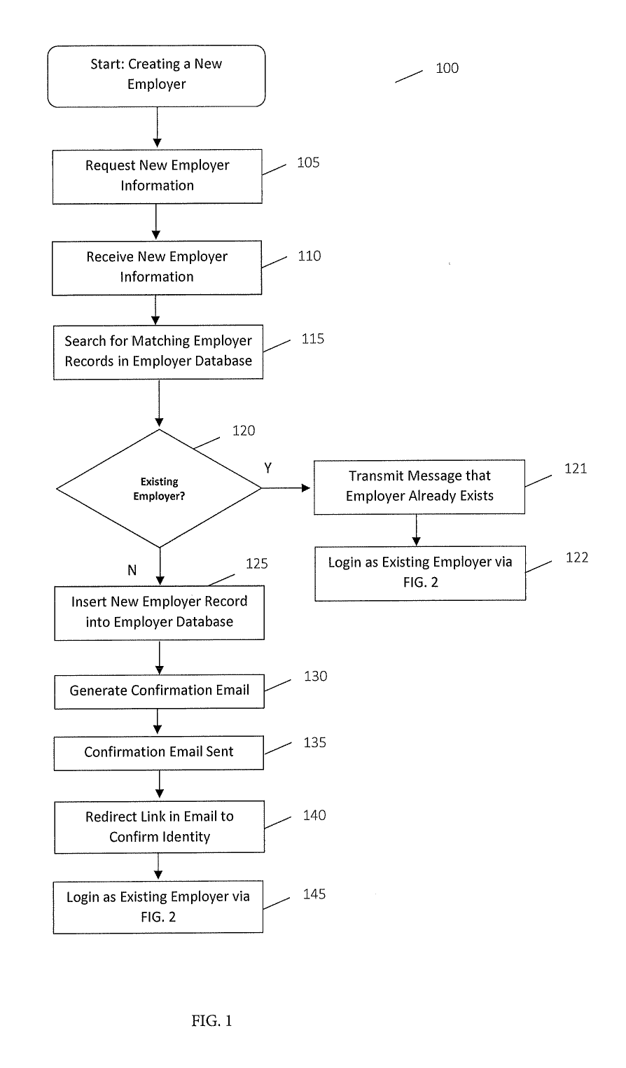

FIG. 1, Creating New Employer

Referring to FIG. 1, an exemplary, computer-implemented process 100 for creating a new employer is depicted in flow diagram form. The process includes steps 105 through 145, as shown.

In step 105, a display in generated requesting new employer information.

In step 110, new employer information is received.

In step 115, the process 100 searches for matching employer records in the employer database.

In step 120, the process 100 determines whether or not there's a match.

In step 121, if an employer record is found to match the employer database search, a message that the employer already exists is displayed.

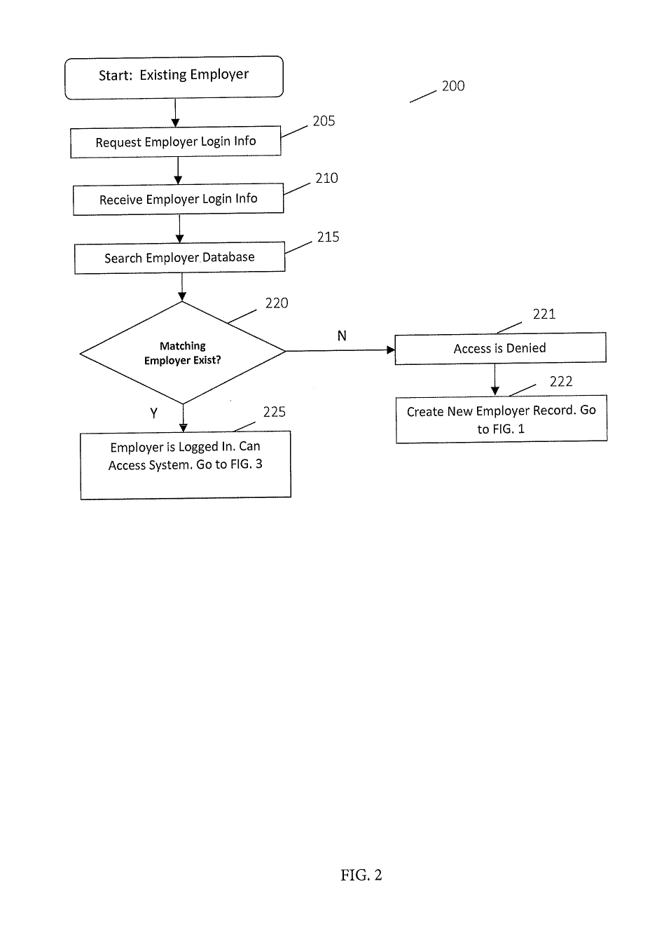

In step 122, process 100 allows for the employer to login as an existing employer via the process flow in FIG. 2.

In step 125, if no matching employer record is found, process 100 will insert the new employer record into the employer database.

In step 130, upon successful insertion of the employer record, a confirmation email is generated.

In step 135, a confirmation email is sent to email via either internal, private messaging system or through existing, commercial messaging system.

In step 140, the new employer is prompted to click on redirect link in email to confirm identity.

In step 145, confirmation, process 100 will allow for the employer to login as an existing employer via the process flow in FIG. 2 and process 100 then ends.

FIG. 2, Accessing Verification System by Existing Employer

FIG. 2 is a flow diagram of a computer-implemented process for accessing the verification system as an existing employer. As shown, the following steps are performed:

Step 200—overall existing employer process.

Step 205—generation of a display requesting employer login information.

Step 210—process 200 receives employer login information.

Step 215—process 200 then searches for matching employer records in the employer database.

Step 220—process 200 determines whether or not there's a match.

Step 221—if no matching employer record is found, transmit a display message that the access is denied.

Step 222—process 200 then allows for the employer to create a new employer record via the process flow in FIG. 1.

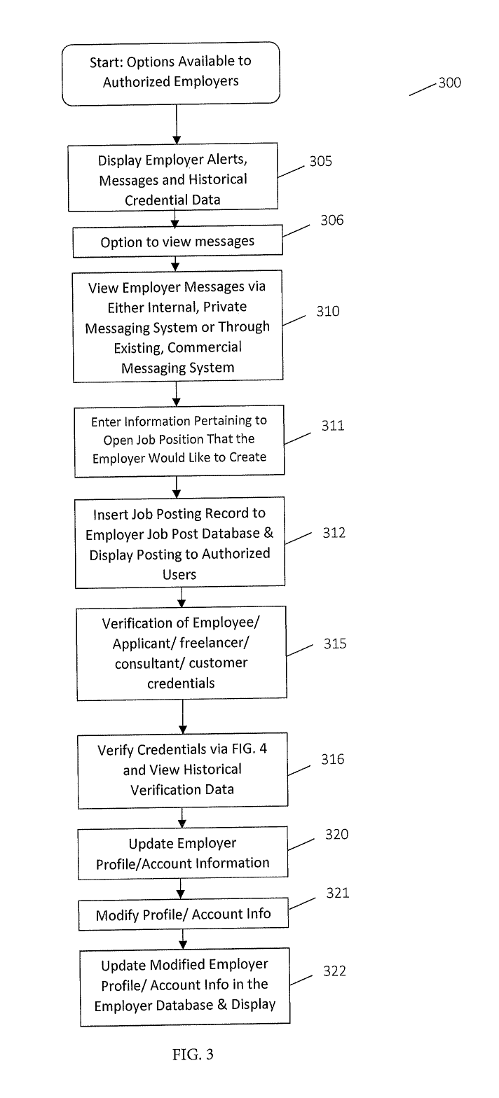

Step 225—if a match is found, employer is successfully logged into the system and system 200 will allow for the employer to access the system via the process flow in FIG. 3 and process 200 then ends.

FIG. 3, Options Available to Authorized Employers

FIG. 3 is a diagram depicting options available to authorized employers:

Block 300—overall employer options.

Block 305—process that allows for the display of employer alerts and messages.

Block 306—allows for the viewing of all read and unread employer messages via either internal, private messaging system or through existing, commercial messaging system.

Block 310—process that allows for the posting of open job positions.

Block 311—allows for the entry of information pertaining to the open job position that the employer would like to create.

Block 312—inserts job posting record to the employer job post database and displays the posting to the authorized users.

Block 315—process that allows for the verification of employee/applicant certifications.

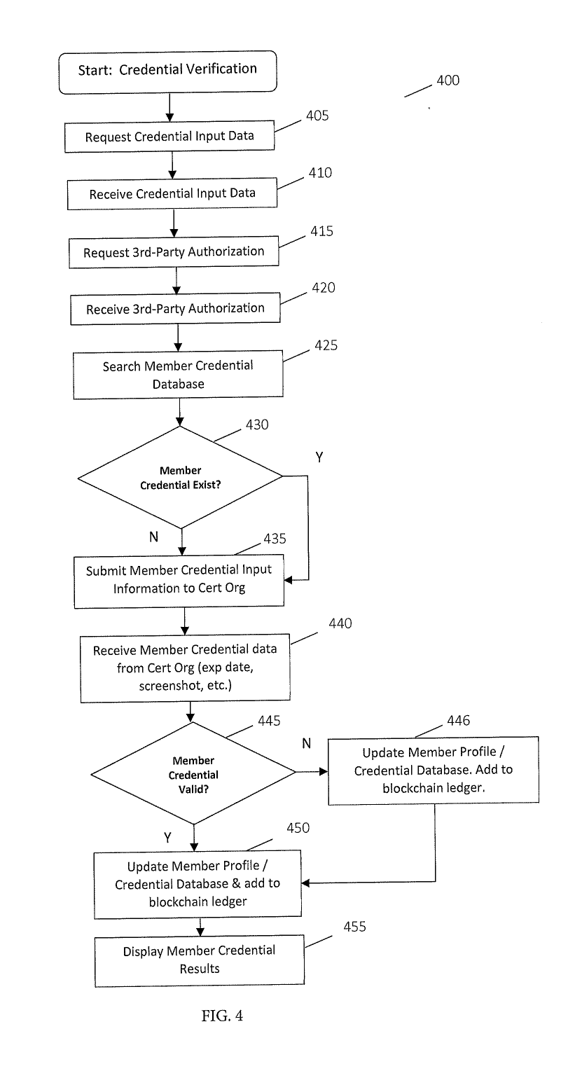

Block 316—process 300 will allow for the employer to verify certifications via the process flow in FIG. 4.

Block 320—allows for the updating of employer profile/account information.

Block 321—allows for the modification of profile/account information.

Block 322—updates the modified employer profile/account into in the employer database, displays it and then process 300 ends.

FIG. 4, Credential Verification

FIG. 4 is a flow diagram of a process for credential verification:

Step 400—overall credential verification process.

Step 405—generation of a display requesting credential information.

Step 410—process 400 receives credential information.

Step 415—generation of a display requesting third party authorization.

Step 420—process 400 receives third party authorization.

Step 425—process 400 then searches for member certification records in the member certification database.

Step 430—process 400 determines whether or not there's a match.

Step 435—process 400 then submits member certification information to the applicable certifying organization either via an API or direct entry at certifying org website.

Step 440—receive member certification status from certifying org either via an API or direct response from certifying org website.

Step 445—process 400 determines whether or not certification is valid or not.

Step 446—if no valid member certification record is determined, process 400 will insert the member certification record into the member certification database with a flag denoting that the certification is not valid and will not display the member certifications.

Step 450—if a valid member certification record is determined record is found, process 400 will insert the member certification record into the member certification database.

Step 455—upon successful insertion of the valid member certification record, process 400 will transmit a message to display the valid member certification information and process 400 then ends.

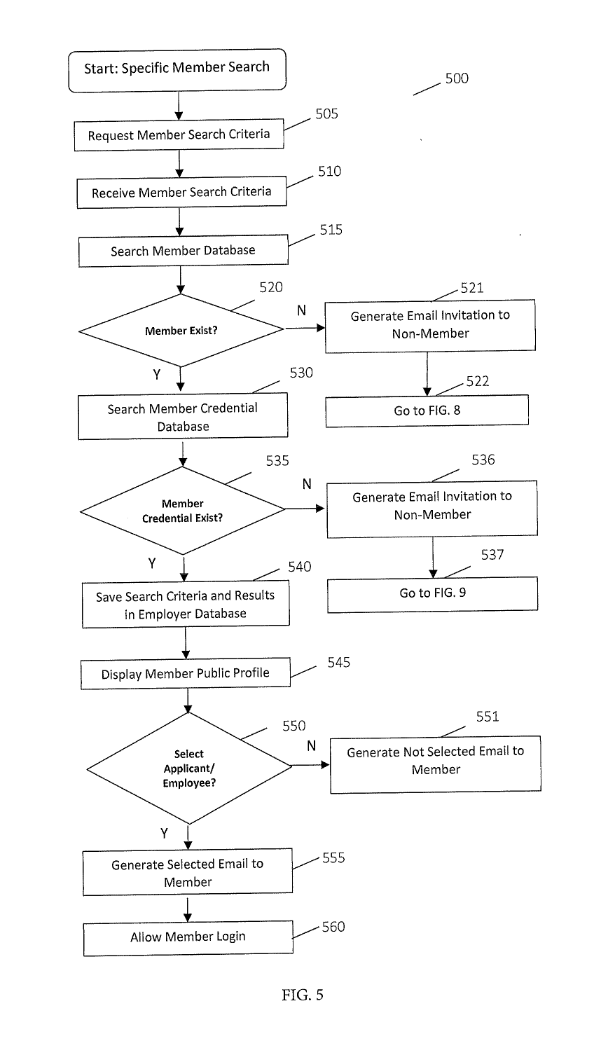

FIG. 5, Searching for Specific Member

FIG. 5 is a flow diagram of a process for searching for a specific member:

Step 500—overall search for a specific member process.

Step 505—generation of a display requesting member search criteria.

Step 510—process 500 receives member search criteria.

Step 515—process 500 then searches for matching member records in the member database.

Step 520—process 500 determines whether or not there's a match.

Step 521—if no matching member record is found, process 500 generates an email invitation to the non-member which is sent via either internal, private messaging system or through existing, commercial messaging system.

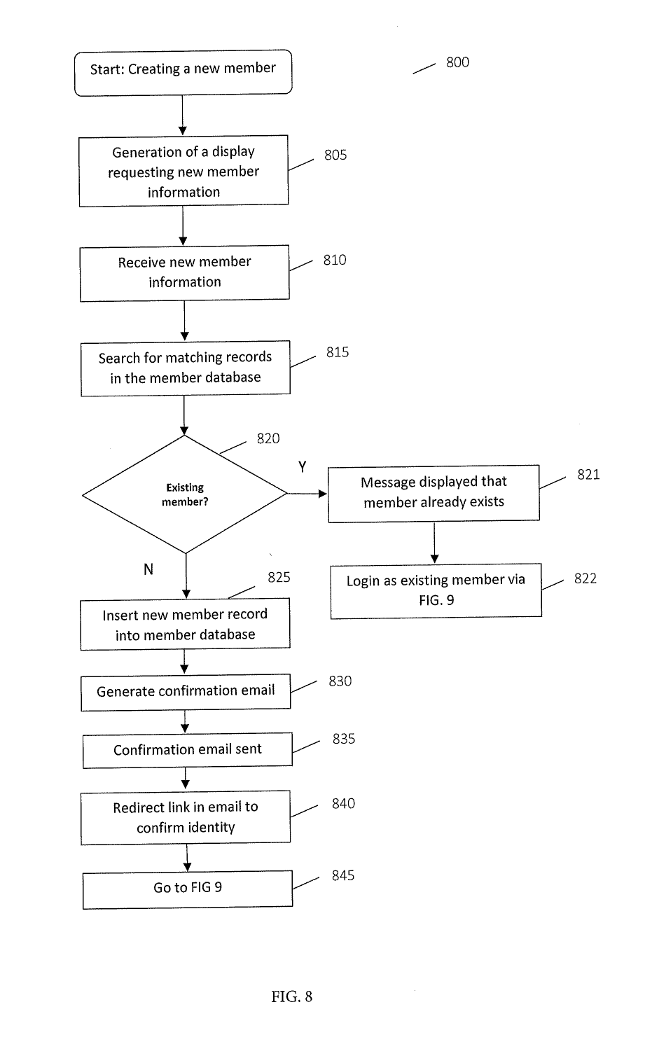

Step 522—process 500 then allows for the non-member to continue the process via the process flow in FIG. 8.

Step 530—if a matching member record is found, process 500 then searches for matching member certification records in the member certification database.

Step 535—process 500 determines whether or not there's a match.

Step 536—if no matching member record is found, process 500 generates an email invitation to the member which is sent via either internal, private messaging system or through existing, commercial messaging system.

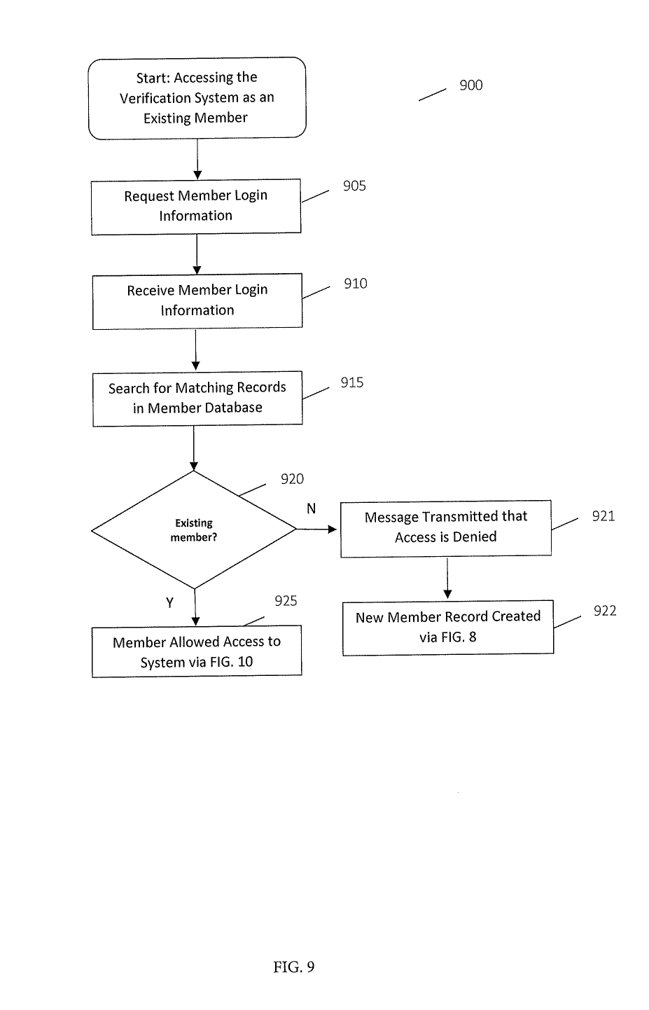

Step 537—process 500 then allows for the member to continue the process via the process flow in FIG. 9.

Step 540—process 500 then saves the search criteria and search results in the employer database.

Step 545—member public profile is then displayed.

Step 550—employer will elect whether or not to select an applicant/employee.

Step 551—if employer does not select a member, process 500 generates a not selected email to the member which is sent via either internal, private messaging system or through existing, commercial messaging system.

Step 555—if employer does select a member, process 500 generates a selected email to the member which is sent via either internal, private messaging system or through existing, commercial messaging system.

Step 560—process 500 will allow for the selected member to login via the process flow in FIG. 9 and process 500 then ends.

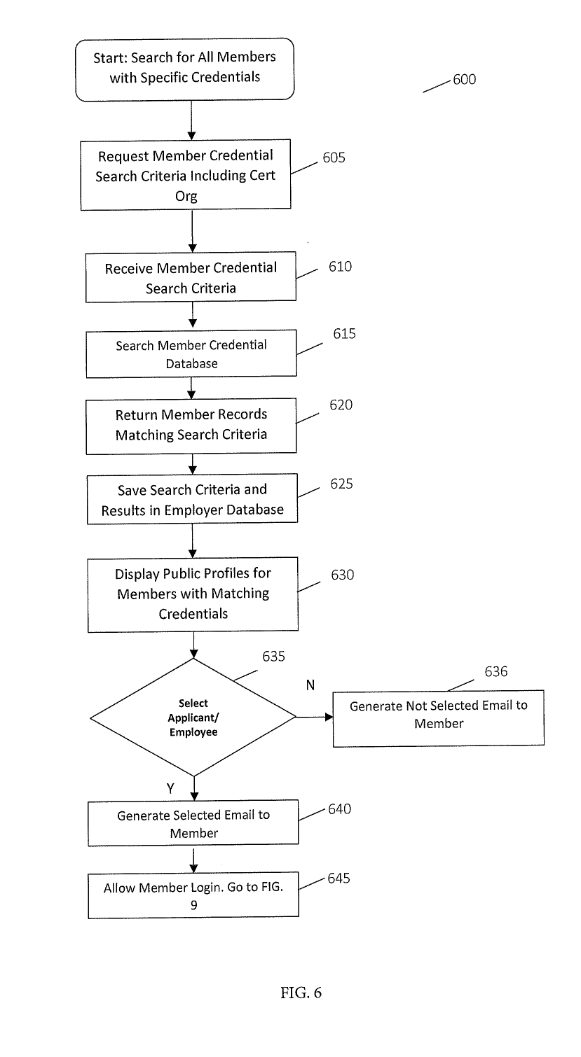

FIG. 6, Searching for all Members with Specific Certifications

FIG. 6 is a flow diagram of a process for searching for all members with specific certifications:

Step 600—overall search for all members with certifications process.

Step 605—generation of a display requesting member certification search criteria.

Step 610—process 600 receives member certification search criteria.

Step 615—process 600 then searches for matching member records in the member certification database.

Step 620—process 600 returns member records matching the search criteria.

Step 625—process 600 then saves the search criteria and search results in the employer database.

Step 630—public profiles for members with matching certification search criteria will be displayed.

Step 635—employer will elect whether or not to select an applicant/employee.

Step 636—if employer does not select a member, process 600 generates a not selected email to the member which is sent via either internal, private messaging system or through existing, commercial messaging system.

Step 640—if employer selects a member, process 600 generates a selected email to the member which is sent via either internal, private messaging system or through existing, commercial messaging system.

Step 645—process 600 will allow for the selected member to login via the process flow in FIG. 9 and process 600 then ends.

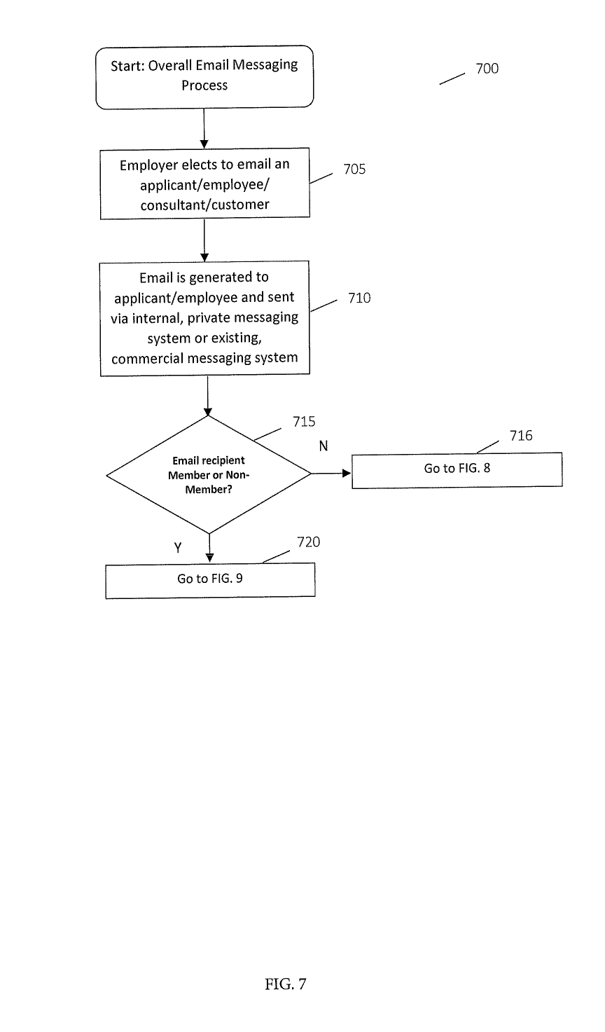

FIG. 7, Sending Email Messages

FIG. 7 is a flow diagram of a process for sending email messages:

Step 700—overall email messaging process.

Step 705—employer will elect to email an applicant/employee.

Step 710—process 700 generates an email to the applicant/employee which is sent via either internal, private messaging system or through existing, commercial messaging system.

Step 715—process 700 will determine whether or not the email is being sent to member.

Step 716—if the email is going to a non-member, the non-member can continue the process via the process flow in FIG. 8.

Step 720—if the email is going to a member, the member can continue the process via the process flow in FIG. 9 and process 700 then ends.

FIG. 8, Creating New Member

FIG. 8 is a flow diagram of a process for creating a new member:

Step 800—overall new member process.

Step 805—generation of a display requesting new member information.

Step 810—process 800 receives new member information.

Step 815—process 800 then searches for matching member records in the member database.

Step 820—process 800 determines whether or not there's a match.

Step 821—if a member record is found to match the member database search, transmit a display message that the member already exists.

Step 822—process 800 then allows for the member to login as an existing member via the process flow in FIG. 9.

Step 825—if no matching member record is found, process 800 will insert the new member record into the member database.

Step 830—upon successful insertion of the member record, a confirmation email is generated by process 800.

Step 835—confirmation email is sent to email via either internal, private messaging system or through existing, commercial messaging system.

Step 840—new member must click on redirect link in email to confirm identity.

Step 845—upon confirmation, process 800 will allow for the member to login as an existing member via the process flow in FIG. 9 and process 800 then ends.

FIG. 9, Accessing Verification System

FIG. 9 is a flow diagram of a process for accessing the verification system as an existing member:

Step 900—overall existing member process.

Step 905—generation of a display requesting member login information.

Step 910—process 900 receives member login information.

Step 915—process 900 then searches for a matching member record in the member database.

Step 920—process 900 determines whether or not there's a match.

Step 921—if no matching member record is found, transmit a display message that access is denied.

Step 922—process 900 then allows for the member to create a new member record via the process flow in FIG. 8.

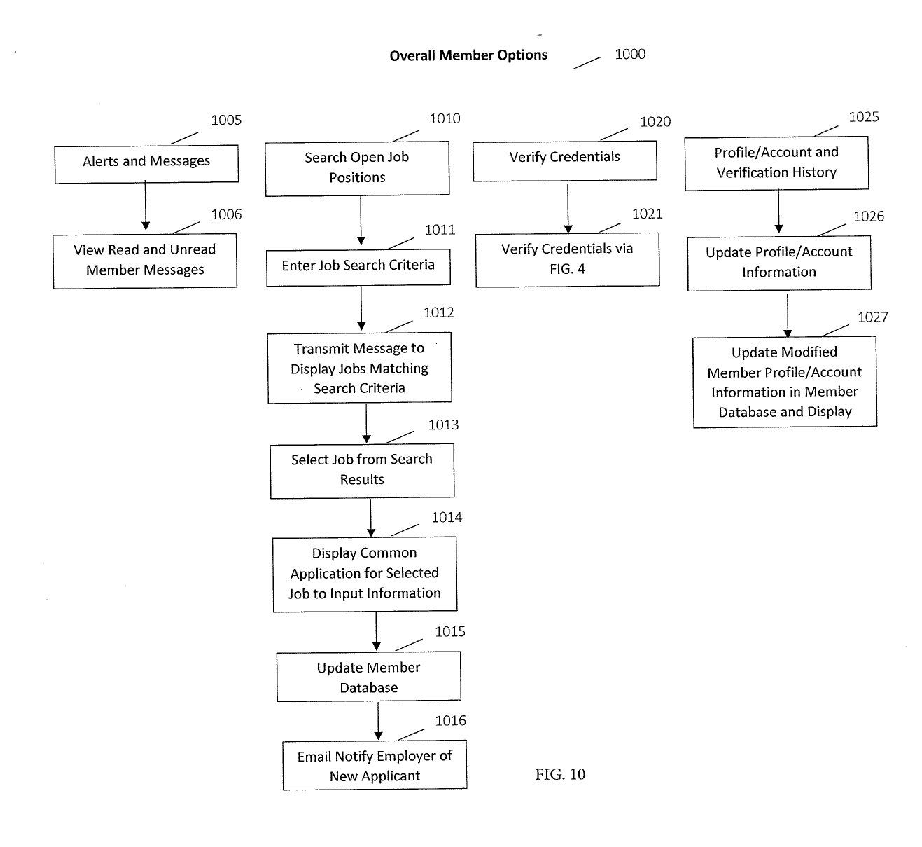

Step 925—if a match is found, member is successfully logged into the system and process 900 will allow for the member to access the system via the process flow in FIG. 10 and process 900 then ends.

FIG. 10, Options Available to Authorized Members

FIG. 10 is a flow diagram of options available to authorized members:

Step 1000—overall member options.

Step 1005—process that allows for the display of member alerts and messages.

Step 1006—process 1000 allows for the viewing of all read and unread member messages via either internal, private messaging system or through existing, commercial messaging system.

Step 1010—process that allows for the searching of open job positions.

Step 1011—allows for the entry of information pertaining to the open job position for which the member would like to search.

Step 1012—process 1000 transmits a message to display jobs matching the search criteria.

Step 1013—allows for the member to select jobs from the search results.

Step 1014—process 1000 displays common job application for selected jobs for member to input application information.

Step 1015—process 1000 updates member database with job application information.

Step 1016—process 1000 will email notify employer of new applicant via either internal, private messaging system or through existing, commercial messaging system.

Step 1020—process that allows for the verification of member certifications.

Step 1021—process 1000 will allow for the member to their verify certifications via the process flow in FIG. 4.

Step 1025—process that allows for the updating of member profile/account information.

Step 1026—process 1000 allows for the modification of profile/account information.

Step 1027—process 1000 updates the modified member profile/account into in the member database, displays it and then process 1000 ends.

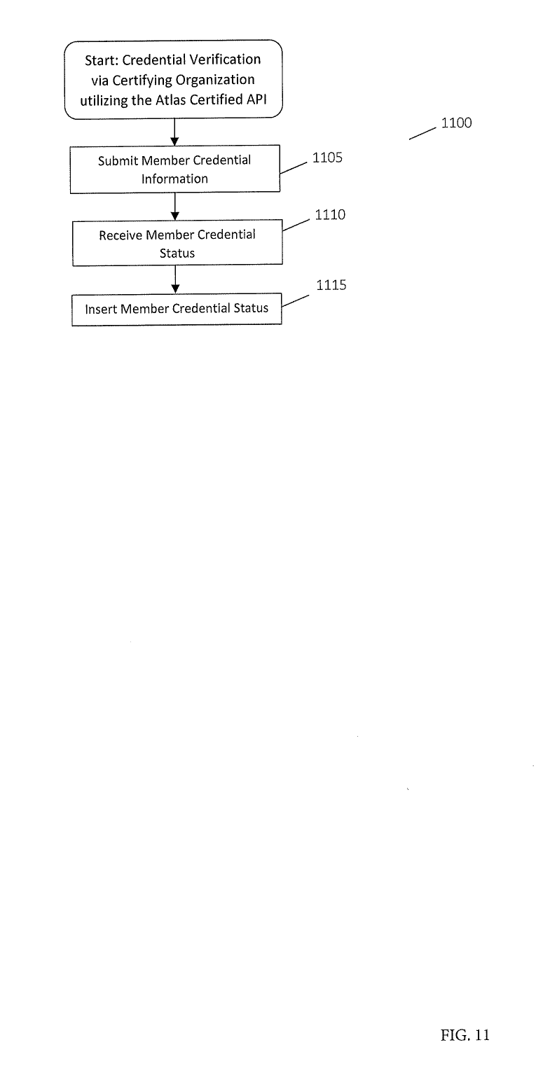

FIG. 11, Searching & Categorizing Additional Certification Data

FIG. 11 is a flow diagram of a process for the certification verification via the Certifying Organization utilizing the Atlas Certified API:

Step 1100—overall certification verification with Certifying Organization process.

Step 1105—process 1100 submits member certification information to the applicable certifying organization via the Atlas Certified API.

Step 1110—receive member certification status from certifying org either via the Atlas Certified API from certifying organization.

Step 1115—insert member certification status; upon successful insertion of the member certification record process 1100 then ends.

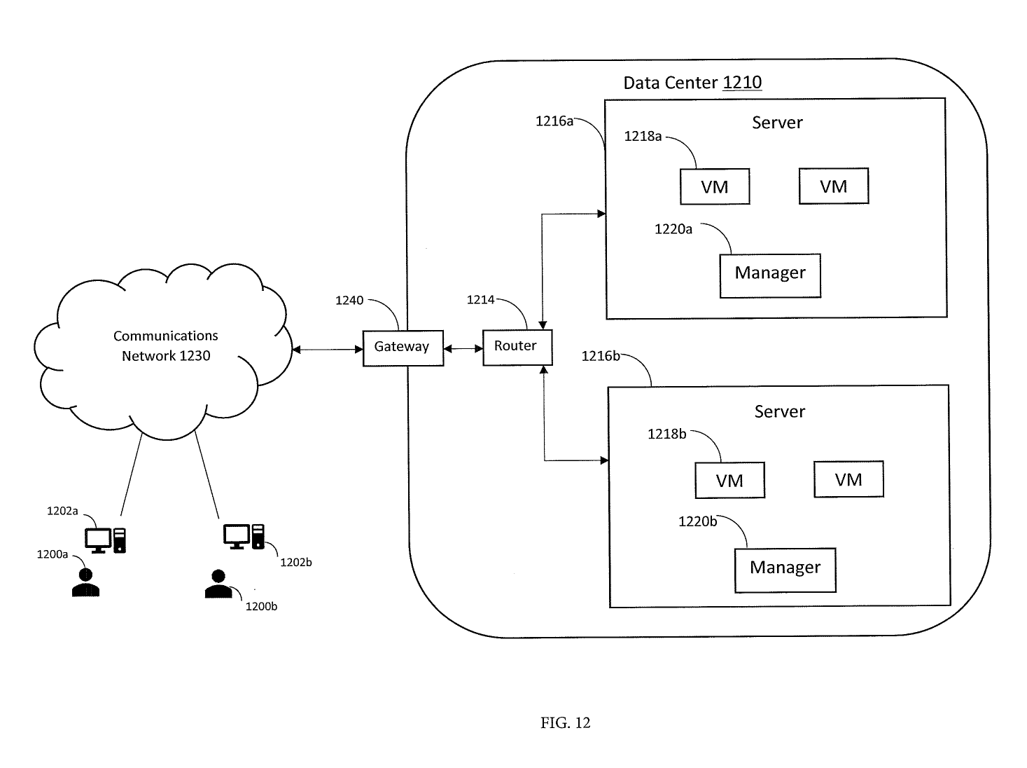

FIG. 12, Computer Network

FIG. 12 illustrates an example “cloud based” computing environment in which the embodiments described herein may be implemented. FIG. 12 is a diagram schematically illustrating an example of a data center 1210 that can provide computing resources to users 1200a and 1200b (which may be referred herein singularly as “a user 1200” or in the plural as “the users 1200”) via user computers 1202a and 1202b (which may be referred herein singularly as “a computer 1202” or in the plural as “the computers 1202”) via a communications network 1230. Data center 1210 may be configured to provide computing resources for executing applications on a permanent or an as-needed basis. The computing resources provided by data center 1210 may include various types of resources, such as data processing resources, data storage resources, data communication resources, and the like. Each type of computing resource may be general purpose or may be available in a number of specific configurations. For example, data processing resources may be available as virtual machine instances. The instances may be configured to execute applications, including web servers, application servers, media servers, database servers, and the like. Data storage resources may include file storage devices, block storage devices, and the like.

Data center 1210 may include servers 1216a and 1216b (which may be referred herein singularly as “a server 1216” or in the plural as “the servers 1216”) that provide computing resources available as virtual machine instances 1218a and 1218b (which may be referred herein singularly as “a virtual machine instance 1218” or in the plural as “the virtual machine instances 1218”). The virtual machine instances 1218 may be configured to execute applications, including Web servers, application servers, media servers, database servers, and the like. Other resources that may be provided include data storage resources (not shown) and may include file storage devices, block storage devices, and the like. The availability of virtualization technologies for computing hardware has provided benefits for providing large scale computing resources for customers and allowing computing resources to be efficiently and securely shared between multiple customers. For example, virtualization technologies, such as those provided by VMware or other virtualization systems, may allow a physical computing device to be shared among multiple users by providing each user with one or more virtual machine instances hosted by the physical computing device.

Referring to FIG. 12, communications network 1230 may, for example, be a publicly accessible network of linked networks and possibly operated by various distinct parties, such as the Internet. In other embodiments, communications network 1230 may be a private network, such as, for example, a corporate network that is wholly or partially inaccessible to non-privileged users. In still other embodiments, communications network 1230 may include one or more private networks with access to and/or from the Internet. Communications network 1230 may provide access to computers 1202. Computers 1202 may be computers utilized by customers 1200 or other customers of data center 1210. For instance, user computer 1202a or 1202b may be a server, a desktop or laptop personal computer, a tablet computer, a wireless telephone, a personal digital assistant (PDA), an e-book reader, a game console, a set-top box, or any other computing device capable of accessing data center 1210. User computer 1202a or 1202b may connect directly to the Internet (e.g., via a cable modem or a Digital Subscriber Line (DSL)). Although only two user computers 1202a and 1202b are depicted, it should be appreciated that there may be multiple user computers.

Computers 1202 may also be utilized to configure aspects of the computing resources provided by data center 1210. In this regard, data center 1210 might provide a Web interface through which aspects of its operation may be configured through the use of a Web browser application program executing on user computer 1202. Alternatively, a stand-alone application program executing on user computer 1202 might access an application programming interface (API) exposed by data center 1210 for performing the configuration operations. Other mechanisms for configuring the operation of the data center 1210, including deploying updates to an application, might also be utilized.

Servers 1216a and 1216b (which may be referred herein singularly as “a server 1216” or in the plural as “the servers 1216”) shown in FIG. 12 may be standard servers configured appropriately for providing the computing resources described above and may provide computing resources for executing one or more applications. In one embodiment, the computing resources may be virtual machine instances 1218. In the example of virtual machine instances, each of the servers 1216 may be configured to execute an instance manager 1220a or 1220b (which may be referred herein singularly as “an instance manager 1220” or in the plural as “the instance managers 1220”) capable of executing the virtual machine instances. It should be appreciated that although the embodiments disclosed above discuss the context of virtual machine instances, other types of implementations can be utilized with the concepts and technologies disclosed herein. For example, the embodiments disclosed herein might also be utilized with computing systems that do not utilize virtual machine instances.

In the example data center 1210 shown in FIG. 12, a router 1214 may be utilized to interconnect the servers 1216a and 1216b. Router 1214 may also be connected to gateway 240, which is connected to communications network 1230. Router 1214 may manage communications within networks in data center 1210, for example, by forwarding packets or other data communications as appropriate based on characteristics of such communications (e.g., header information including source and/or destination addresses, protocol identifiers, etc.) and/or the characteristics of the private network (e.g., routes based on network topology, etc.). It will be appreciated that, for the sake of simplicity, various aspects of the computing systems and other devices of this example are illustrated without showing certain conventional details. Additional computing systems and other devices may be interconnected in other embodiments and may be interconnected in different ways.

It should be appreciated that the network topology illustrated in FIG. 12 has been greatly simplified and that many more networks and networking devices may be utilized to interconnect the various computing systems disclosed herein. These network topologies and devices should be apparent to those skilled in the art.

It should also be appreciated that data center 1210 described in FIG. 12 is merely illustrative and that other implementations might be utilized. Additionally, it should be appreciated that the functionality disclosed herein might be implemented in software, hardware, or a combination of software and hardware. Other implementations should be apparent to those skilled in the art. It should also be appreciated that a server, gateway, or other computing device may comprise any combination of hardware or software that can interact and perform the described types of functionality, including without limitation desktop or other computers, database servers, network storage devices and other network devices, PDAs, tablets, cellphones, wireless phones, pagers, electronic organizers, Internet appliances, television-based systems (e.g., using set top boxes and/or personal/digital video recorders), and various other consumer products that include appropriate communication capabilities. In addition, the functionality provided by the illustrated modules may in some embodiments be combined in fewer modules or distributed in additional modules. Similarly, in some embodiments the functionality of some of the illustrated modules may not be provided and/or other additional functionality may be available.

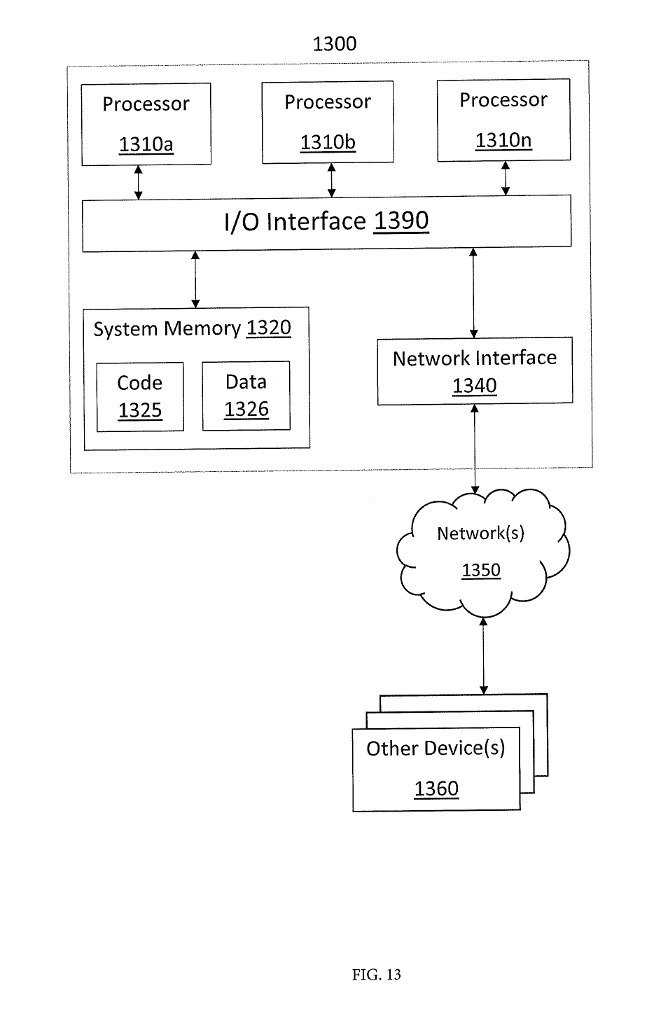

FIG. 13, Computer

FIG. 13 illustrates such a general-purpose computing device 1300 of the type suited for carrying out the computer-implemented processes described above. In at least some embodiments, a server that implements a portion or all of one or more of the technologies described herein, including the techniques to implement the functionality of a resource analysis service 180 may include a general-purpose computer system that includes or is configured to access one or more computer-accessible media. In the illustrated embodiment, computing device 1300 includes one or more processors 1310a, 1310b, and/or 1310n (which may be referred herein singularly as “a processor 1310” or in the plural as “the processors 1310”) coupled to a system memory 1320 via an input/output (I/O) interface 1390. Computing device 1300 further includes a network interface 1340 coupled to I/O interface 1390. In various embodiments, computing device 1300 may be a uniprocessor system including one processor 1310 or a multiprocessor system including several processors 1310 (e.g., two, four, eight, or another suitable number). Processors 1310 may be any suitable processors capable of executing instructions. For example, in various embodiments, processors 1310 may be general purpose or embedded processors implementing any of a variety of instruction set architectures (ISAs), such as the x86, PowerPC, SPARC, or MIPS ISAs, or any other suitable ISA. In multiprocessor systems, each of processors 1310 may commonly, but not necessarily, implement the same ISA.

System memory 1320 may be configured to store instructions and data accessible by processor(s) 1310. In various embodiments, system memory 1320 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing one or more desired functions, such as those methods, techniques, and data described above, are shown stored within system memory 1320 as code 1325 and data 1326.

In one embodiment, I/O interface 1390 may be configured to coordinate I/O traffic between processor 1310, system memory 1320, and any peripheral devices in the device, including network interface 1340 or other peripheral interfaces. In some embodiments, I/O interface 1390 may perform any necessary protocol, timing, or other data transformations to convert data signals from one component (e.g., system memory 1320) into a format suitable for use by another component (e.g., processor 1310). In some embodiments, I/O interface 1390 may include support for devices attached through various types of peripheral buses, such as a variant of the Peripheral Component Interconnect (PCI) bus standard or the Universal Serial Bus (USB) standard, for example. In some embodiments, the function of I/O interface 1390 may be split into two or more separate components, such as a north bridge and a south bridge, for example. Also, in some embodiments some or all of the functionality of I/O interface 1390, such as an interface to system memory 1320, may be incorporated directly into processor 1310.

Network interface 1340 may be configured to allow data to be exchanged between computing device 1300 and other device or devices 1360 attached to a network or network(s) 1350. In various embodiments, network interface 1340 may support communication via any suitable wired or wireless general data networks, such as types of Ethernet networks, for example. Additionally, network interface 1340 may support communication via telecommunications/telephony networks, such as analog voice networks or digital fiber communications networks, via storage area networks, such as Fibre Channel SANs or via any other suitable type of network and/or protocol.

In some embodiments, system memory 1320 may be one embodiment of a computer-accessible medium configured to store program instructions and data as described above for implementing embodiments of the corresponding methods and apparatus. However, in other embodiments, program instructions and/or data may be received, sent or stored upon different types of computer-accessible media. Generally speaking, a computer-accessible medium may include non-transitory storage media or memory media, such as magnetic or optical media, e.g., disk or DVD/CD coupled to computing device 1300 via I/O interface 1390. A non-transitory computer-accessible storage medium may also include any volatile or non-volatile media, such as RAM (e.g. SDRAM, DDR SDRAM, RDRAM, SRAM, etc.), ROM, etc., that may be included in some embodiments of computing device 1300 as system memory 1320 or another type of memory. Further, a computer-accessible medium may include transmission media or signals such as electrical, electromagnetic or digital signals, conveyed via a communication medium such as a network and/or a wireless link, such as may be implemented via network interface 1340. Portions or all of multiple computing devices, such as those illustrated in FIG. 13, may be used to implement the described functionality in various embodiments; for example, software components running on a variety of different devices and servers may collaborate to provide the functionality. In some embodiments, portions of the described functionality may be implemented using storage devices, network devices, or special purpose computer systems, in addition to or instead of being implemented using general purpose computer systems. The term “computing device,” as used herein, refers to at least all these types of devices and is not limited to these types of devices.

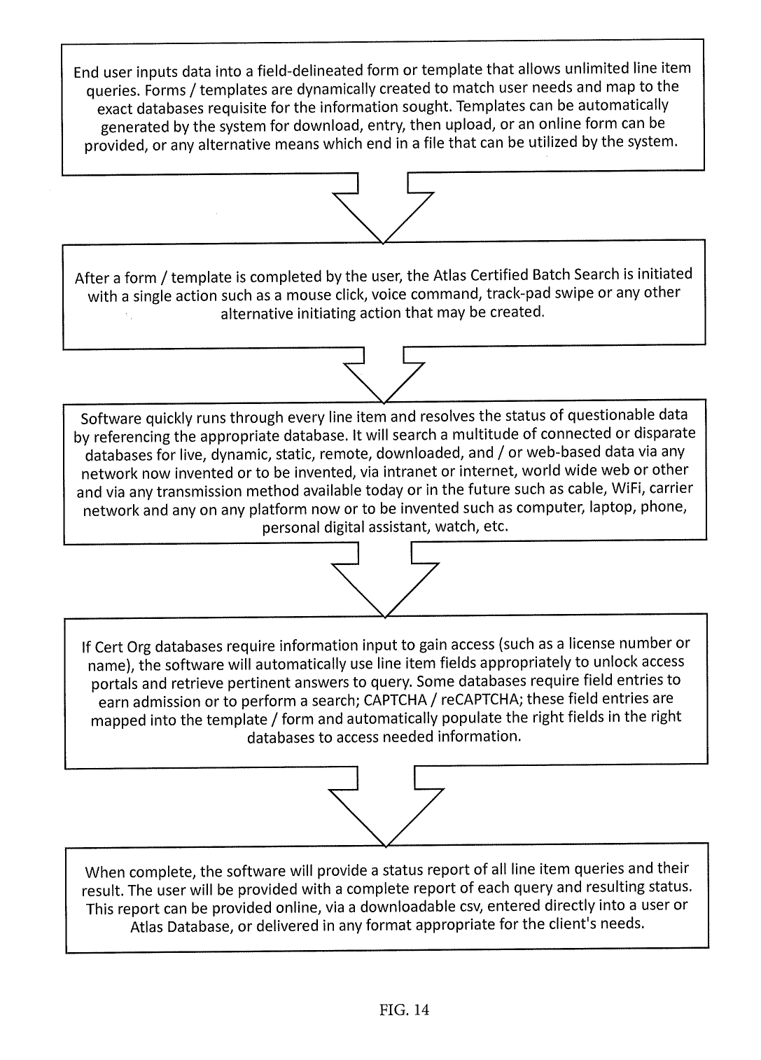

FIG. 14, Batch Verification

FIG. 14 is a flow diagram of a batch credential verification process. This aspect of the technology relates to the general field of data searching and has certain specific application to background checking and verification processes. However, this aspect of the invention can be applied to any situation where multiple items need to be processed as a batch and may or may not require culling information from multiple databases. By way of background, in general, search functions are usually limited to single item/individuals checked against a singular database. Multiple fields offered in these searches are still only relative to the one unique query. Checking or obtaining information about a list of items/individuals against the same and/or multiple connected or disconnected databases by this method is time consuming and often tedious.

FIG. 14 shows the process by which questionable information about multiple individuals and/or things is checked against multiple source databases in one single step for the user. For a technical recruiter needing to check the verity and status of candidate technical certifications, this system provides a one-step verification process for multiple applicants. The user would input any number of name and credential combinations to search a multitude of databases for live, dynamic, static, remote, downloaded, and/or web-based data. Entry can be done via an automated template creator, an online form or any other such method whereby data is mapped into a searchable format.

The Atlas Certified Batch Search allows for this single template or field-mapped file to launch the concurrent search of multiple names and multiple certifications, which may or may not be verifiable in corresponding databases. It will simultaneously query all names with all corresponding databases and return a status report on all individual certifications within the same original file format or any end format the client desires.

As an example, Recruiter A has 40 new applicants for a job. All applicants claim to have valid certifications from several disparate professional organizations. Each professional organization has its own unique database and certification verification retrieval process. Currently, Recruiter A would have to perform a search for each individual, and each individual's various certifications, one by one by entering the pertinent information directly into the certifying body's web portal for certification verification. So if Applicant B lists 5 different certifications, each one of these would require multiple steps on multiple sites to ascertain their validity. In addition, once the information is gleaned from each search, Recruiter A will have to compile all the information manually in some sort of database or spreadsheet. This system is inefficient, tedious and a waste of human resources. With the Atlas Certified Batch Search, every single applicant in question can be entered in one form locally and or remotely by the Recruiter and with one step, every candidate will have all their various certifications checked automatically against the corresponding parent organization's database for such.

The Atlas Certified Batch Search will instantly launch the concurrent search of multiple names and multiple related or unrelated certifications against multiple connected or disparate databases for live, dynamic, static, remote, downloaded, and/or web-based data in an automated process which requires no further effort on the part of the end user. In most cases, each certifying body requires some field entries on their website to gain admission to their database. For example, Cert. C requires a last name and certification number for verification. Atlas Certified Batch Search will automatically map the Recruiter's form data to the website's field data required for admission. Once the Atlas Certified Batch Search is finished, the Recruiter is provided with a complete status report on all applicants and the validity of their certification. In addition, the system can be designed to retrieve and report any and all available information for an individual from the professional databases such as when a certification is due to expire. The report can be saved as a csv or any other format which the Recruiter can either save as is or edit. The Recruiter never has to leave the interface hosting the Atlas Certified Batch Search to access and verify data across various disconnected websites and is left with a neat, compiled report of the results. This process could be used to check the validity of licenses of all kinds, medical, construction, real estate or more.

The process depicted in FIG. 14 may be summarized as follows:
1. End user inputs questionable data into a field-delineated form or template that allows unlimited line item queries. Forms/templates are dynamically created to match user needs and map to the exact databases requisite for the information sought. Templates can be automatically generated by the system for download, entry, then upload, or an online form can be provided, or any alternative means which end in a file that can be utilized by the system.
2. After a form/template is completed by the user, the Atlas Certified Batch Search is initiated with a single action such as a mouse click, voice command, track-pad swipe or any other alternative initiating action that may be created.
3. Software quickly runs through every line item and resolves the status of questionable data by referencing the appropriate database. It will search a multitude of connected or disparate databases for live, dynamic, static, remote, downloaded, and/or web-based data via any network now invented or to be invented, via intranet or internet, world wide web or other and via any transmission method available today or in the future such as cable, WiFi, carrier network and any on any platform now or to be invented such as computer, laptop, phone, personal digital assistant, watch, etc.
4. When faced with databases that need information input to gain access (such as a license number or name), the software will automatically use line item fields appropriately to unlock access portals and retrieve pertinent answers to query. Some databases require field entries to earn admission or to perform a search; these field entries are mapped into the template/form and automatically populate the right fields in the right databases to access needed information.
5. When done, the software will provide a status report of all line item queries and their result. The user will be provided with a complete report of each query and resulting status. This report can be provided online, via a downloadable csv, entered directly into a user or Atlas Database, or delivered in any format appropriate for the client's needs.

Illustrative Algorithms

To conclude the present disclosure, we provide below two illustrative software-based algorithms suitable for use in implementing the inventive system described above. These algorithms are tailored to address specific problems encountered in creating an automated and distributed system for verifying certification and license data. The algorithms include a Verification Tracking Algorithm and an Adverse Action Algorithm.

Verification Tracking Algorithm

This is an information processing algorithm by computer software in the certificate verification system, comprising the steps of submitting a verification request, queuing the verification request, processing the verification request, updating the underlying certificate, and storing the certificate status. Each status for the verification request process, as well as the final status related to the underlying certification are defined below.

QUEUED, AWAITING PROCESSING

A verification request is placed in a programmatic queue for processing.

QUEUED, AWAITING PROVIDER AVAILABILITY

A verification request is in the programmatic queue, but the provider is not available. Request has been requeued.

QUEUED, PROVIDER TEMPORARILY UNAVAILABLE

A verification request is in the programmatic queue, has attempted to be processed, but the provider is not available.

QUEUED, REPLACED BY NEWER ACTION

A verification request in the programmatic queue has been replace by a duplicate verification request which takes its place in the queue.

PROCESSING

A verification request is being processed.

PROCESSING COMPLETE—CERTIFICATION UPDATED

Once a verification request is processed and has been completed.

PROCESSING COMPLETE—CERTIFICATION NOT UPDATED

Once a verification request is processed and request has been completed, but due to an error the certification has not been updated.

COMPLETED, VERIFIED

Once the underlying certification has been updated, the verification request is COMPLETED and the certification has been updated.

COMPLETED, UNABLE TO VERIFY

Once the underlying certification has been updated, the verification request is COMPLETED, UNABLE TO VERIFY, and the certification is updated.

Adverse Action Algorithm

This is an information processing algorithm by computer software in the certificate verification system, comprising the steps of evaluating a completed verification request, applying a decision matrix to determine the existence of an adverse event, and generating a notification. The adverse event process for a completed certification request is detailed below.

CHANGED ATTRIBUTES

The attributes that have changed based on the completion of the certification request are loaded into memory.

EXCEPTIONS LOGIC

Ignore the below criteria for certification requests in which notifications are turned off.

TIME BASED CRITERIA

The expiration date attribute is evaluated for 30, 60 and 90-day pre-expiration status based on the expiration date minus the current date. Meeting any of the criteria will trigger a notification event queue item. For new time-based criteria, “grandfathered” 60 or 90-day pre-expiration statuses are ignored.

STATUS BASED CRITERIA

EXPIRED

The expiration date attribute is evaluated against the current date. If the expiration date is less than the current date, if true, and adverse notification event queue item is added.

REVOKED

The expiration date attribute is evaluated against the current expiration date. If the attribute is less than the current expiration date, and adverse notification event queue item is added.

PROCESSING OF QUEUE

At the configured time interval, the adverse notification event queue is processed, and notifications sent.

We claim:

1. A system for automatically verifying and monitoring digital records, comprising:
a digital processor; and
a computer readable medium comprising executable instructions that, when executed, cause the system to automatically execute a verification process and a monitoring process for verifying and monitoring digital records including licenses and certifications.

2. The system of claim 1, wherein the verification process comprises the following steps:
generate a display requesting certification information;
receive certification information;
generate a display requesting third party authorization;
receive third party authorization;
search for member certification records in member certification database;
determine whether or not there is a match;
submit member certification information to an applicable certifying organization;
receive member certification status from certifying organization;
determine whether or not certification is valid;
if no valid member certification record is determined, insert the member certification record into the member certification database with a flag denoting that the certification is not valid and will not display the member certifications;
if a valid member certification record is found, insert the member certification record into the member certification database;
upon successful insertion of the valid member certification record, transmit a message to display the valid member certification information.

3. The system of claim 1, wherein the monitoring process comprises the following steps:
receiving a verification request from a customer, the verification request including defined search criteria, including a credential holder name and identifier, wherein the verification request is received via a web-based dashboard interface or an application programming interface (API);
requesting input data from the customer to ensure an accurate match;
assigning a unique number to the verification request and queuing the verification request for processing by a distributed verification engine, wherein the distributed verification engine is programmed to search for and identify the next verification request in queue and automatically execute the verification process on the next verification request;
aggregating both structured and unstructured verification data without human intervention;
determining whether the credential is valid, active, expired, or includes a discrepancy;
capturing all metadata associated with the verification, the metadata including data representing an expiration date, address, adverse actions, and/or disciplinary actions;
automatically capturing a screen shot of the certification organization's website to provide a visual record of what the system encountered when it captured the verification, and making the screenshot available in a verification history for each verification processed; and
adding the data results to the credential holder's profile history.

4. The system of claim 3, further comprising adding verification results to a blockchain distributed ledger, thereby providing an unalterable audit log.

5. The system of claim 3, further comprising providing automatic notifications based on status, including change of status from active to expired.

6. The system of claim 2, wherein the monitoring process employs customizable triggers and alerts to provide notifications for change in status of a license or certification being monitored.

7. The system of claim 6, wherein the change in status of a license or certification being monitored includes one or more of: normal expiration, disciplinary action, administrative action, revocation, and pre-expiration.

8. The system of claim 1, wherein the system further comprises instructions that, when executed, cause the system to execute a process to simulate a browser visiting a website of an external web-based system, submitting requests, and parsing returned data to capture data pertinent to licenses and certifications maintained by the external web-based system.

9. The system of claim 8, wherein the external web-based system provides information via form submissions but does not make available an application programming interface (API) suitable to capture data.

10. The system of claim 1, wherein the system further comprises instructions that, when executed, cause the system to employ blockchain technology to make verification data part of a distributed ledger, thereby creating an unalterable audit log of all of verifications processed.

11. The system of claim 10, wherein the audit log provides a globally searchable database of individuals and their licenses that outputs a verification stored in the blockchain.

12. The system of claim 1, wherein the system further comprises instructions that, when executed, cause the system to execute a CSV import process to create a comma separated values file in a correct format for bulk uploads depending on user selected verification types.

13. A process for automatically verifying and monitoring digital records, comprising:
a verification process for verifying digital records including licenses and certifications; and
a monitoring process for monitoring said licenses and certifications;
wherein the verification process comprises the following steps:
generating a display requesting certification information;
receiving certification information;
generating a display requesting third party authorization;
receiving third party authorization;
searching for member certification records in member certification database;
determining whether or not there is a match;
submitting member certification information to an applicable certifying organization;
receiving member certification status from certifying organization;
determining whether or not certification is valid;
if no valid member certification record is determined, inserting the member certification record into the member certification database with a flag denoting that the certification is not valid and will not display the member certifications;
if a valid member certification record is found, inserting the member certification record into the member certification database; and
upon successful insertion of the valid member certification record, transmitting a message to display the valid member certification information.

14. The method of claim 13, wherein the monitoring process comprises the following steps:
receiving a verification request from a customer, the verification request including defined search criteria, including a credential holder name and identifier, wherein the verification request is received via a web-based dashboard interface or an application programming interface (API);
requesting input data from the customer to ensure an accurate match;
assigning a unique number to the verification request and queuing the verification request for processing by one of a distributed verification engine, wherein the distributed verification engine is programmed to search for and identify the next verification request in queue and automatically execute the verification process on the next verification request;
aggregating both structured and unstructured verification data without human intervention;
determining whether the credential is valid, active, expired, or includes a discrepancy;
capturing all metadata associated with the verification, the metadata including data representing an expiration date, address, adverse actions, and/or disciplinary actions;
automatically capturing a screen shot of the certification organization's website to provide a visual record of what the system encountered when it captured the verification, and making the screenshot available in a verification history for each verification processed; and
adding the data results to the credential holder's profile history.

15. The method of claim 13, wherein the monitoring process employs customizable triggers and alerts to provide notifications for change in status of a license or certification being monitored, wherein the change in status includes normal expiration, disciplinary action, administrative action, revocation, or pre-expiration.

16. The method of claim 13, wherein the method further comprises a process to simulate a browser visiting a website of an external web-based system, submitting requests, and parsing returned data to capture data pertinent to licenses and certifications maintained by the external web-based system.

17. The method of claim 16, wherein the external web-based system provides information via form submissions but does not make available any application programming interface (API).

18. The method of claim 13, wherein the method further comprises a process to employ blockchain technology to make verification data part of a distributed ledger, thereby creating an unalterable audit log of all of verifications processed.

19. The method of claim 18, wherein the audit log provides a globally searchable database of individuals and their licenses that outputs a verification stored in the blockchain.

20. The method of claim 13, wherein the method further comprises a CSV import process to create a comma separated values file in a correct format for bulk uploads depending on user selected verification types.

21. A computer readable medium comprising executable instructions, that, when executed, cause the system to:
execute a verification process for verifying digital records including licenses and certifications; and
execute a monitoring process for monitoring said licenses and certifications;
wherein the verification process comprises the following steps:
generating a display requesting certification information;
receiving certification information;
generating a display requesting third party authorization;
receiving third party authorization;
searching for member certification records in member certification database;
determining whether or not there is a match;
submitting member certification information to an applicable certifying organization;
receiving member certification status from certifying organization;
determining whether or not certification is valid;
if no valid member certification record is determined, inserting the member certification record into the member certification database with a flag denoting that the certification is not valid and will not display the member certifications;
if a valid member certification record is found, inserting the member certification record into the member certification database; and
upon successful insertion of the valid member certification record, transmitting a message to display the valid member certification information; and
wherein the monitoring process comprises the following steps:
receiving a verification request from a customer, the verification request including defined search criteria, including a credential holder name and identifier, wherein the verification request is received via a web-based dashboard interface or an application programming interface (API);
requesting input data from the customer to ensure an accurate match;
assigning a unique number to the verification request and queuing the verification request for processing by one of a distributed verification engine, wherein the distributed verification engine is programmed to search for and identify the next verification request in queue and automatically execute the verification process on the next verification request;
aggregating both structured and unstructured verification data without human intervention;
determining whether the credential is valid, active, expired, or includes a discrepancy;
capturing all metadata associated with the verification, the metadata including data representing an expiration date, address, adverse actions, and/or disciplinary actions;
automatically capturing a screen shot of the certification organization's website to provide a visual record of what the system encountered when it captured the verification, and making the screenshot available in a verification history for each verification processed; and
adding the data results to the credential holder's profile history.
